(19) United States
(12) Patent Application Publication
(10) Pub. No.: US 2025/0341669 A1
(43) Pub. Date: Nov. 6, 2025

(54) DISPLAY SYSTEM AND OPTICAL SHIFTING FILM THEREOF

(71) Applicant: AUO Corporation, Hsinchu City (TW)

(72) Inventors: Yueh-Heng LEE, Hsinchu City (TW); Chia-Hung CHEN, Hsinchu City (TW); Shih-Fu Tseng, Hsinchu City (TW)

(21) Appl. No.: 18/980,525

(22) Filed: Dec. 13, 2024

(30) Foreign Application Priority Data
May 3, 2024 (TW) 113116604
Aug. 7, 2024 (TW) 113129538

(51) Int. Cl. F21V 8/00; G02B 27/01; G02F 1/1335; G02F 1/13357

(52) U.S. Cl. CPC G02B 6/0038; G02B 6/0053; G02B 6/0068; G02B 27/0101; G02B 2027/013; G02F 1/133607; G02F 1/133611

(57) ABSTRACT

A display system and an optical shifting film are provided. The display system includes a projection surface, a display module and a virtual eye area. The display module is disposed corresponding to the projection surface and generates an image light reflected from the projection surface to generate an image in the virtual eye area. A backlight module of the display module includes a light source module and the optical shifting film disposed corresponding to the light emitting side of the light source module. The optical shifting film includes a substrate and a plurality of first prisms, wherein the first prisms are arranged in a first direction and respectively extend along a second direction. The emitted light field generated by at least a portion of the light emitting units closer to the first side of the optical shifting film is shifted in the first direction by the first prisms.

### CROSS REFERENCE TO RELATED APPLICATION

This application claims the priority benefits of Taiwan Patent Application No. 113116604, filed on May 3, 2024 and Taiwan Patent Application No. 113129538, filed on Aug. 7, 2024. The entirety of each of the mentioned above patent applications is hereby incorporated by reference herein and made a part of this specification.

### BACKGROUND OF THE DISCLOSURE

### 1. Field of the Disclosure

The disclosure relates to a display system and an optical shifting film thereof. Specifically, the disclosure relates to a head-up display (HUD) system and an optical shifting film thereof.

### 2. Description of the Prior Art

With the rapid development of display technology, its applications and scope have become increasingly broad. To consider the convenience and safety of users when operating specific devices, such as vehicles and other means of transportation, one application of display technology is the head-up display (HUD) for drivers.

Traditionally, the HUDs in vehicle are relatively small and offer limited information, such as just the speed or a few basic indicators. However, with changes in driving culture and interface design concepts, user demand for a larger display area on the HUD has significantly increased. Additionally, the presence of HUDs can reduce the frequency and duration of drivers looking down, thereby enhancing safety while driving. As a result, the design trend for vehicle interfaces is inevitably moving towards increasing the display area of the HUD.

However, due to external environmental constraints of the HUD, such as the thickness and curvature of the front windshield, driver cabin position, and installation location, various considerations must be made in the optical design of the HUD, and image quality is often compromised. Moreover, the demand for larger display areas of the HUDs frequently results in non-uniform brightness across the display region, leading to difficulties and inconveniences for users to read information.

### SUMMARY OF THE DISCLOSURE

An objective of the disclosure is to provide a display system with more uniform image brightness within its display region.

Another objective of the present disclosure is to provide an optical shifting film suitable for a backlight module, wherein the emitted light field of each light emitting unit within the backlight module is differentiated to increase the uniformity of brightness in the combined light field.

In one aspect, the backlight module includes a light source module and an optical shifting film. The light source module includes a plurality of light emitting units arranged in an array. The optical shifting film is disposed corresponding to the light emitting side of the light source module to receive the source light generated from the light emitting units, wherein the source light forms a shifted emitted light field through the optical shifting film. The optical shifting film includes a substrate and a plurality of first prisms disposed on the substrate. The substrate has a first side that intersects a first direction and extends along a second direction. The first prisms are arranged in the first direction and respectively extend along the second direction. Each of the first prisms has a first major prism face and a first minor prism face. At least a portion of an emitted light field generated by the light emitting units that are closer to the first side is shifted toward the first side in the first direction through the first prisms that receive the light.

In another aspect, a display system includes a projection surface, a display module and a virtual eye area, wherein the display module includes the aforementioned backlight module. The display module is disposed corresponding to the projection surface and generates an image light which is reflected by the projection surface to generate an image at least in the virtual eye area.

### BRIEF DESCRIPTION OF THE APPENDED DRAWINGS

FIG. 1A and FIG. 1B are schematic diagrams of the display system according to an embodiment of the present invention.

FIG. 2A is a schematic diagram of an embodiment of the display system.

FIG. 2B is a schematic diagram of an embodiment of the display module in the display system.

FIG. 3 is a schematic diagram of an embodiment of the backlight module.

FIG. 4A and FIG. 4B are schematic diagrams of an embodiment of the emitted light field.

FIG. 5 is a schematic diagram of another embodiment of the backlight module.

FIG. 6 is a schematic diagram of another embodiment of the optical shifting film.

FIG. 7 is a schematic diagram of another embodiment of the optical shifting film.

FIG. 8A is a schematic diagram of another embodiment of the backlight module.

FIG. 8B is a schematic diagram of another embodiment of the backlight module.

FIG. 8C is a schematic diagram of another embodiment of the backlight module.

FIG. 9 is a schematic diagram of an embodiment of the original emitted light field.

FIG. 10A is a schematic diagram of another embodiment of the original emitted light field.

FIG. 10B is a schematic diagram of another embodiment of the optical shifting film.

FIG. 11 is a schematic diagram of another embodiment of the display system.

FIG. 12 is a schematic diagram of another embodiment of the display module.

### DETAILED DESCRIPTION OF THE DISCLOSURE

Various embodiments will be described below, and those of ordinary skill in the art can easily understand the spirits and principles of the present invention referring to this specification accompanied by the drawings. However, although some particular embodiments will be specifically illustrated herein, these embodiments are only exemplary, and are not to be regarded as limiting or exhaustive in all respects. Therefore, for those of ordinary skill in the art, various changes and modifications to the present invention should be obvious and can be easily achieved without departing from the spirits and principles of the present invention.

In the appended drawings, thicknesses of layers, films, panels, regions and so on are enlarged for clarity. Throughout this specification, the same reference numerals refer to the same elements. It will be understood that when an element such as layer, film, region or substrate is referred to as being “on” or “connected to” another element, it can be directly on or connected to the other element, or intervening elements may also be present. In contrast, when an element is referred to as being “directly on” or “directly connected to” another element, there are no intervening elements present. As used herein, “connected” may refer to a physical and/or electrical connection.

It should be understood that, even though the terms such as “first”, “second”, “third” may be used to describe an element, a part, a region, a layer and/or a portion in the present specification, but these elements, parts, regions, layers and/or portions are not limited by such terms. Such terms are merely used to differentiate an element, a part, a region, a layer and/or a portion from another element, part, region, layer and/or portion. Therefore, in the following discussions, a first clement, portion, region, layer or portion may be called a second element, portion, region, layer or portion, and do not depart from the teaching of the present disclosure.

The terms used herein are to describe particular embodiments only and are not limiting. As used herein, the singular forms “a”, “an”, and “the” are intended to include the plural forms, including “at least one”, unless the content dictates otherwise. “Or” means “and/or”. As used herein, the term “and/or” includes any and all combinations of one or more of the associated listed items. It will also be understood that, when used in this specification, the terms “comprising” and/or “including” designate the presence or addition of stated features, regions, integers, steps, operations, elements, and/or components, but do not exclude the presence or addition of one or more other features, regions, integers, steps, operations, elements, components and/or combinations thereof.

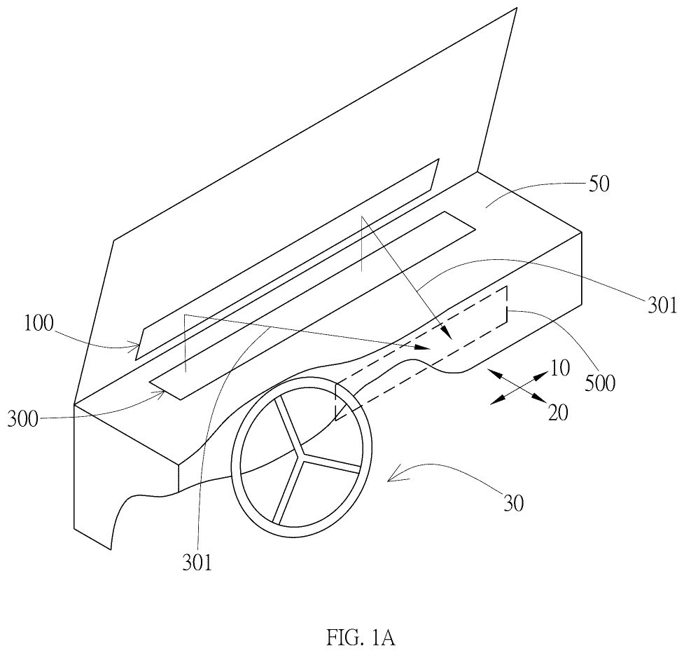

The disclosure relates to a display system and an optical shifting film thereof. In an embodiment, the display system is used as a HUD in vehicles, other transportation devices or other devices that require user operation. In addition, the display system of the disclosure can be applied in near-eye displays or other projection display devices. In the embodiment shown in FIG. 1A and FIG. 1B, the display system includes a projection surface 100, a display module 300 and a virtual eye area 500. In the embodiment that the display system is disposed in a vehicle, the projection surface 100 can be, for example, the front windshield of the vehicle, but is not limited thereto. In addition, the projection surface 100 can be a portion of the front windshield, such as the band-shaped area near the bottom of the lower half of the front windshield. The display module 300 is set at an angle to the projection surface 100, for example, an acute angle between 0° to 90°. In the embodiment shown in FIG. 1A and FIG. 1B, the display module 300 is disposed on a top 50 of the vehicle dashboard and console. As shown in FIG. 1A and FIG. 1B, the display module 300 is extended along a first direction 10. The first direction 10 can be, for example, the long side direction of the projection surface 100, or the extension direction of the boundary between the projection surface 100 and the top 50 of the dashboard and consol. When the display system is disposed in a vehicle, the first direction 10 can be the vehicle width direction that is perpendicular to the forward moving direction of the vehicle.

As shown in FIG. 1A and FIG. 1B, the vehicle or other device in which the display system is disposed has a driver or other user cabin 30. When the driver or other users are in the cabin 30, their eye positions are restricted to a certain space range due to their sitting, standing or other postures. This space range serves as an exemplary definition of the virtual eye area 500. Therefore, although the virtual eye area 500 is not a specific physical device structure, it serves as a reference region for imaging when designing the imaging part of the display system. For example, this reference region is provided by the car manufacturer to the HUD designer and can be defined by the control design of the cabin 30 in the vehicle or other devices, as well as the default ergonomic design for the driver/user. Since the potential movement range and varying body types of users are taken into consideration during the cabin design process, the virtual eye area 500 can be formed as a band or columnar range with a longer length in the first direction 10. Specifically, for example, by estimating the possible eye positions of users with heights between 150 cm and 190 cm while seated, an embodiment range of the virtual eye area 500 can be obtained.

As shown in FIG. 1A and FIG. 1B, the display module 300 is disposed corresponding to the projection surface 100, so that the image light 301 generated by the display module 300 can be projected onto the projection surface 100 and reflected by the projection surface 100 to generate an image at least in the virtual eye area 500. Preferably, the image seen by the driver/user in the virtual eye area 500 is a virtual image generated after the image light 301 is reflected by the projection screen 100.

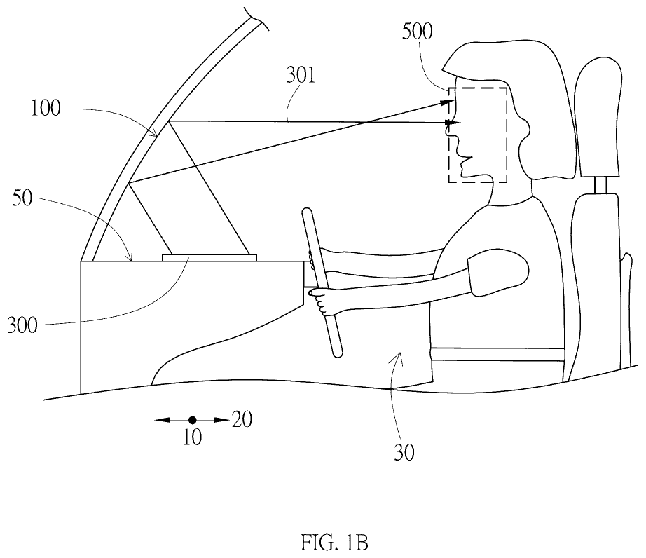

In the embodiment shown in FIG. 2A, the virtual eye area 500 has a first upright central axis 501 in an upright direction relative to the ground; the projection surface 100 has a second upright central axis 101 in an upright direction relative to the ground. In this embodiment, the aforementioned “upright” is not limited to vertical positions, but includes other upright states that are not parallel to the ground and form non-right angles to the ground. The first upright central axis 501 and the second upright central axis 101 together define a first virtual upright plane 210, and an intersection line 303 between the virtual upright plane 201 and the display module 300 has a midpoint. By extending from the midpoint in a direction perpendicular to the first direction 10 and parallel to the display module 300, an axis of symmetry 302 can be formed. Preferably, the display module 300 exhibits bilateral symmetry with respect to the axis of symmetry 302.

FIG. 2B shows an embodiment of the display module 300. In this embodiment, the display module 300 includes a display panel 310 and a backlight module 330. The display panel 310 can be, for example, a liquid crystal display panel, and is disposed on the light emitting side of the backlight module 330. After the light generated by the backlight module 330 reaches the display panel 310, the light is modulated through the display panel 310 to generate the image light 301. In this embodiment, the backlight module 330 includes a light source module 700. The light source module 700 includes a plurality of light emitting units 710. The light emitting units 710 are arranged in an array, such as a checkerboard arrangement, a hexagonal close arrangement, or other types of arrangements. In the embodiment shown in FIG. 2B, the array arrangement of the light emitting units 710 extends along the first direction 10.

The backlight module 330 further includes an optical shifting film 400 disposed on the light emitting side of the light source module 700. As shown in FIG. 2B, the optical shifting film 400 includes a substrate 410 and a plurality of first prisms 430. The substrate 410 has a first side 411. The first side 411 intersects the first direction 10 and extends along a second direction 20. The substrate 410 also has an upper surface 413, and the first prisms 430 are disposed on the upper surface 413 of the substrate 410. In an embodiment, the plurality of first prisms 430 are integrally formed with the substrate 410, for example, by cutting, etching, printing or other processes; however, in another embodiment, the plurality of the first prisms 430 can be additionally disposed on the substrate 410. The plurality of first prisms 430 are arranged along the first direction 10; that is, the plurality of first prisms 430 are disposed with or without spacing between each other in the first direction 10. In addition, the plurality of first prisms 430 extend along the second direction 20 respectively.

As shown in FIG. 2B, the optical shifting film 400 exhibits bilateral symmetry with respect to the axis of symmetry 302 of the display module 300, so that the emitted light field has good uniformity of brightness within the range of the virtual eye area 500.

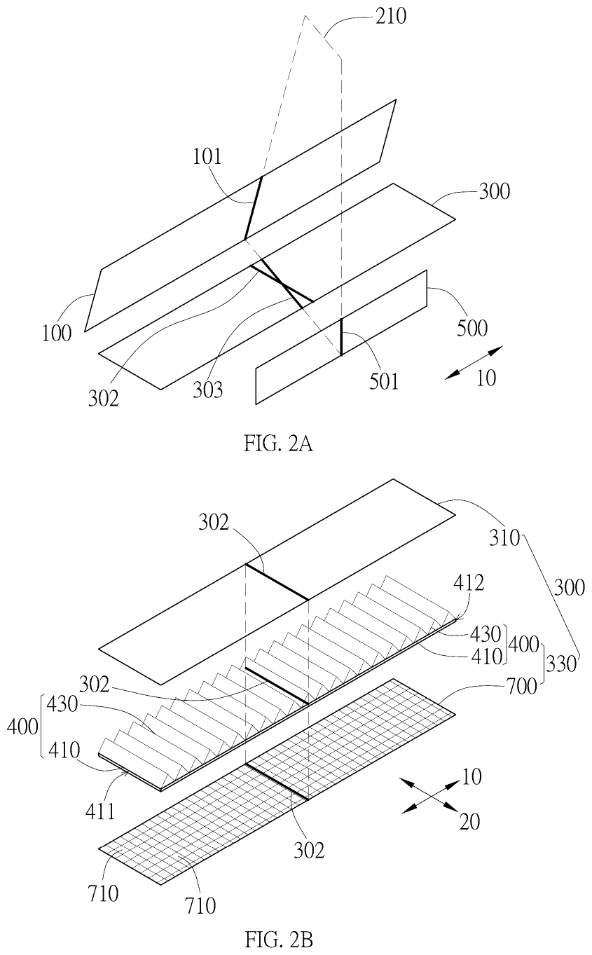

As shown in FIG. 3, the light emitting unit 710 is preferably a light emitting diode and has a light emitting face 715. The optical shifting film 400 is arranged corresponding to the light emitting side of the light emitting units 710, that is, facing the light emitting face 715, to receive the source light 810 generated by the light emitting units 710. The optical shifting film 400 can refract, scatter or otherwise change the light path of the received source light 810 to adjust the emission angle and/or distribution range. As shown in FIG. 3, the emitted light field generated by at least a portion of the light emitting units is shifted in the first direction 10 through a portion of the first prisms 430 disposed above and receiving the corresponding source light 810. In this embodiment, the aforementioned shift of light field is directed toward the first side 411, but is not limited thereto. In this embodiment, the degree of shift of the emitted light field through at least a portion of the first prisms farther from the first side 411 (such as the first prism 430b) is less than the degree of shift of the emitted light field through at least a portion of the first prisms closer to the first side 411 (such as the first prism 430a).

As shown in FIG. 3, each of the first prisms 430 has a first major prism face 431. The first major prism face 431 forms a first major interior angle α₁ with the first direction 10 on a virtual cross-section (which is the plane shown in FIG. 3) that is parallel to the first direction 10 and intersects the second direction 20. The first major interior angle α₁ of at least a portion of the first prisms 430b farther from the first side 411 is smaller than the first major interior angle α₁ of at least a portion of the first prisms 430a closer to the first side 411. In addition, each of the first prisms 430 has a first minor prism face 433 that is opposite to the first major prism face 431. The first minor prism face 433 forms a first minor interior angle β₁ with the first direction 10 on the virtual cross-section (which is the plane shown in FIG. 3) that is parallel to the first direction 10 and intersects the second direction 20. In an embodiment, the first minor interior angle β₁ is less than 90° and greater than the first major interior angle α₁ in order to reduce the chance of light passing through the first minor prism face 433, thereby reducing the impact of the first minor prism face 433 on the light field.

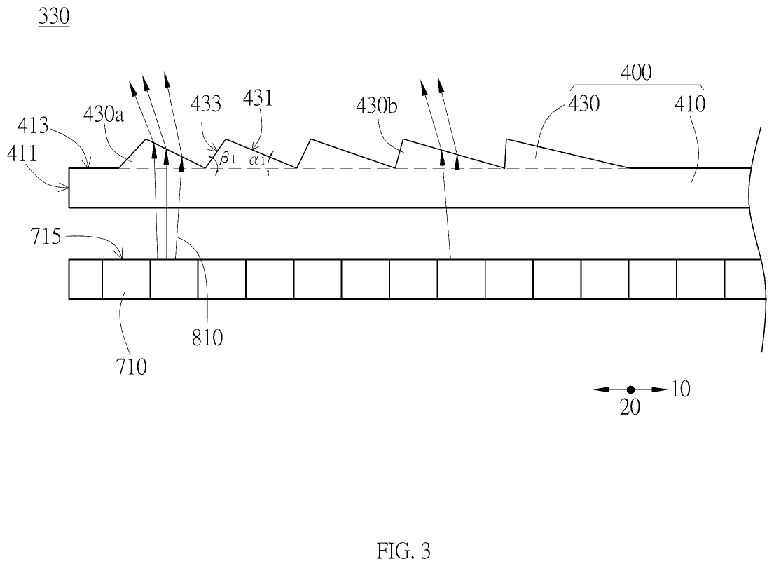

As shown in FIG. 4A and FIG. 4B, the original emitted light field 811 (dashed line part) passes through the optical shifting film 400 to form a shifted emitted light field 830 (solid line part). Specifically, after the source light 810 passes through the optical shifting film 400, the observed shifted light field distribution forms a specific profile. Furthermore, in a variant embodiment, the field pattern observation of the emitted light field 830 may use 50%, 30%, or other different criteria of the maximum intensity of the light field as the lower limit to be included in the field pattern observation; in other words, the light within the set lower limit of field observation can be included in the evaluation of the light field profile. In another embodiment, the lower limit of the light intensity to be included in the field pattern observation may not be set, and all observed light may be included in the evaluation of the light field profile. As shown in FIG. 4B, in the first direction 10, after the original emitted light field 811 passes through the optical shifting film 400 to form the shifted emitted light field 830, the viewing angle position of the peak in the intensity curve is shifted.

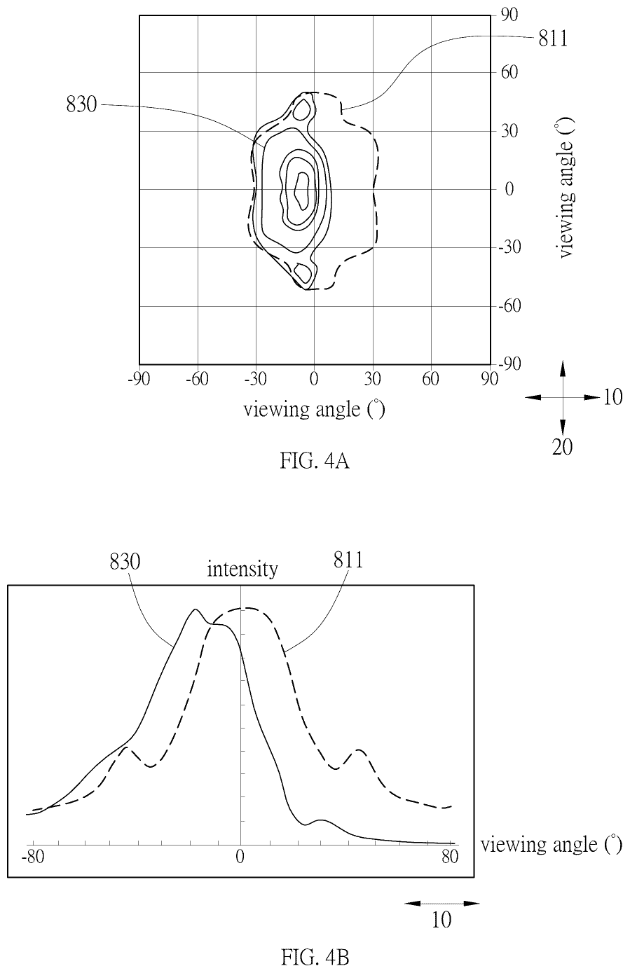

In the embodiment shown in FIG. 5, the substrate 410 has a central part 415, a first part 417 and a second part 419. The first part 417 is located between the central part 415 and the first side 411. The second part 419 is located on the other side of the central part 415 opposite to the first part 417, that is, between the central part 415 and a second side 412 that is opposite to the first side 411. The first prisms 430 are disposed on the first part 417, and the second prisms 450 are disposed on the second part 419. The second prisms 450 are arranged along the first direction 10; that is, the second prisms 450 are disposed with or without spacing between each other in the first direction 10. In addition, the second prisms 450 extend along the second direction 20 respectively.

The emitted light field generated by at least a portion of the light emitting units 710a that are closer to the first part 417 is shifted in the first direction 10 through the first prisms 430a/430b, and the emitted light field generated by at least a portion of the light emitting units 710b that are closer to the second part 419 is shifted in the first direction 10 through the second prisms 450a/450b, in which these two emitted light field are shifted toward opposite directions. In the embodiment shown in FIG. 5, the emitted light field generated by at least a portion of the light emitting units 710a that are closer to the first part 417 is shifted away from the central part 415 in the first direction 10 through the first prisms 430a/430b that are disposed above and receive the corresponding light. In another aspect, the emitted light field generated by at least a portion of the light emitting units 710b that are closer to the second part 419 is shifted away from the central part 415 in the first direction 10 through the second prisms 450a/450b that are disposed above and receive the corresponding light.

In this embodiment, the degree of shift of the emitted light field through at least a portion of the first prisms 430b closer to the central part 415 is less than the degree of shift of the emitted light field through at least a portion of the first prisms 430a farther from the central part 415. The degree of shift of the emitted light field through at least a portion of the second prisms 450b closer to the central part 415 is less than the degree of shift of the emitted light field through at least a portion of the second prisms 450a farther from the central part 415. However, the present invention is not limited thereto. In addition, the aforementioned degree of shift can be evaluated, for example, by the peak position of the intensity curve in the first direction 10; a larger shift in peak position can be regarded as a greater degree of shift.

As shown in FIG. 5, each of the second prisms 450 has a second major prism face 451. The second major prism face 451 forms a second major interior angle α₂ with the first direction 10 on a virtual cross-section (which is the plane shown in FIG. 5) that is parallel to the first direction 10 and intersects the second direction 20. The second major interior angle α₂ of at least a portion of the second prisms 450b closer to the central part 415 is smaller than the second major interior angle α₂ of at least a portion of the second prisms 450a farther from the central part 415. In addition, for the first prisms 430, the first major interior angle α₁ of at least a portion of the first prisms 430b closer to the central part 415 is smaller than the first major interior angle α₁ of at least a portion of the first prisms 430a farther from the central part 415. With the above configuration, the emitted light field closer to the side can be controlled to exhibit a greater degree of shift.

In an embodiment, the projection surface 100 can be a curved surface and has an arc on the cross-section formed by the first direction 10 and the second direction 20. Preferably, the first major interior angle α₁ and the second major interior angle α₂ gradually decrease as they get closer to the central part 415. The variation rates of the above changes are greater when closer to the central part 415 than when farther away from the central part. With the above configuration, the uniformity of brightness at both ends in the first direction 10 within the field of view is more similar to that of the central part within the field of view.

Furthermore, each of the second prisms 450 has a second minor prism face 453 opposite to the second major prism face 451. The second minor prism face 453 forms a second minor interior angle β₂ with the first direction 10 on the virtual cross-section (which is the plane shown in FIG. 5) that is parallel to the first direction 10 and intersects the second direction 20. In an embodiment, the second minor interior angle β₂ is less than 90° and greater than the second major interior angle α₂ in order to reduce the chance of light passing through the second minor prism face 453, thereby reducing the impact of the second minor prism face 453 on the light field.

In an embodiment, the first major interior angle α₁ and/or the second major interior angle α₂ is greater than 0° and less than or equal to 30°. In another embodiment, the first major interior angle α₁ and/or the second major interior angle α₂ is greater than 0° and less than or equal to 20°. With the above configuration, the brightness of the entire light field can be controlled to be more uniform, making it less noticeable for users to perceive significant differences in brightness.

In an embodiment, the light generated by the backlight module 330 and reflected by the projection surface 100 to the virtual eye area 500 has an included angle θ₁ with the first direction 10 on the virtual cross-section that is parallel to the first direction 10 and intersects the second direction 20 upon leaving the optical shifting film 400. Preferably, the first minor interior angle β₁ and the second minor interior angle β₂ can be less than or equal to the aforementioned included angle θ₁ of the lights emitted from the first major prism face 431 and the second major prism face 451, wherein the first minor interior angle β₁ and the second minor interior angle β₂ are measured in the same direction as the corresponding included angle θ₁. With this configuration, the chances of light passing through the first minor prism face 433 and/or the second minor prism face 453 are reduced, thereby reducing the impact of the first minor prism face 433 and/or the second minor prism face 453 on the light field.

Through the aforementioned settings, which the emitted light field generated by each light emitting unit 710 is shifted and differentiated, the overall brightness distribution of the combined emitted light field is more uniform. Therefore, a more uniform image brightness is achieved across the entire field of view of the display system, minimizing the occurrence of excessively low brightness in certain areas that negatively impacts the user's visual experience.

In the aforementioned embodiments, the first major prism face 431 and the second major prism face 451 have substantially identical lengths on the virtual cross-section that is parallel to the first direction 10 and intersects the second direction 20. The first minor prism face 433 and the second minor prism face 453 have shorter lengths near the central part 415 and longer lengths towards the sides. In addition, the first minor interior angle β₁ and the second minor interior angle β₂ are smaller near the central part 415 and larger towards the sides. Relatively speaking, the heights of the first major prisms 430 and the second major prisms 450 are lower near the central part 415 to gradually approach the height of the central part 415, and are higher towards the sides. In addition, the apex angle included between the first major prism face 431 and the first minor prism face 433 is remained the same. In terms of the manufacturing process, the structural configurations in the aforementioned embodiments can be achieved by using a rotary knife combined with height adjustments. However, in the embodiment shown in FIG. 3, due to the absence of a central part, the manufacturing process can be performed solely with the rotary knife, without the need for height adjustments.

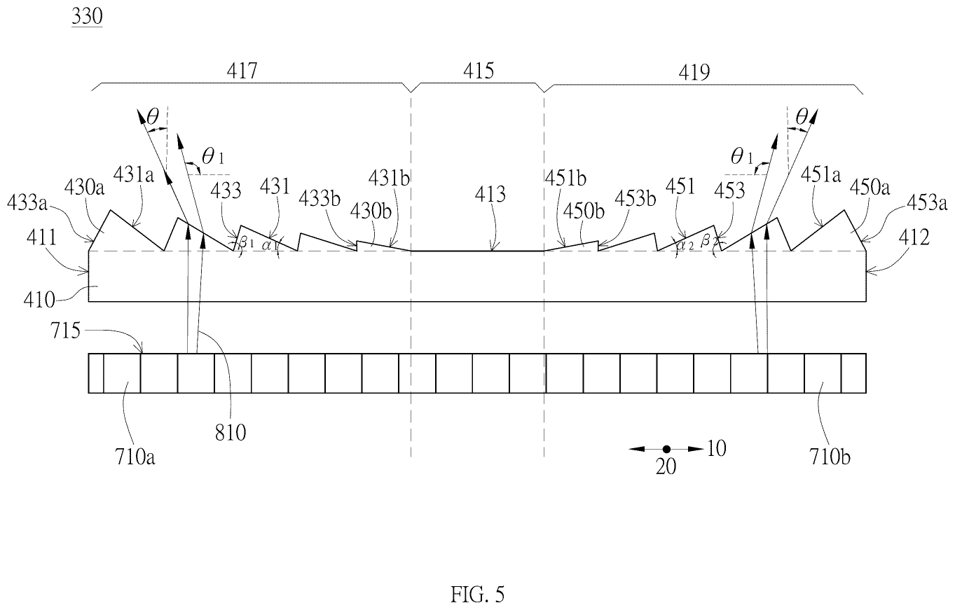

In another embodiment shown in FIG. 6, the first major prism face 431 has a first length L on the virtual cross-section that is parallel to the first direction 10 and intersects the second direction 20. The first length L of at least a portion of the first prisms 430b farther from the first side 411 is smaller than the first length L of at least a portion of the first prisms 430a closer to the first side 411. In addition, the first minor interior angle β₁ and the second minor interior angle β₂ of different first prisms 430a/430b are substantially identical. Moreover, as shown in FIG. 6, there are spacings between adjacent first prisms 430a/430b, and the spacing width W is smaller near the first side 411. Furthermore, the apex angle included between the first major prism face 431 and the first minor prism face 433 becomes larger when approaching the central part 415. In terms of the manufacturing process, the aforementioned structural configuration in this embodiment can be achieved without using a rotary knife, instead using a method that involves cutlery replacement with/without height adjustments.

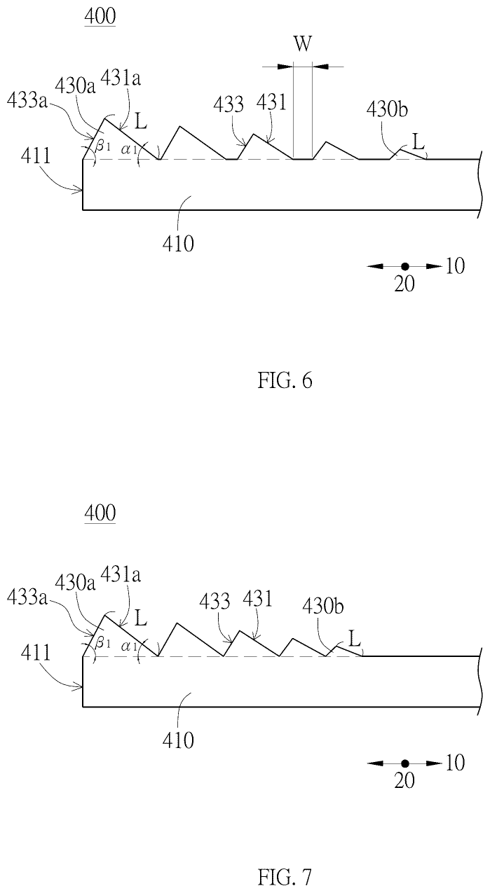

In the embodiment shown in FIG. 7, similar to the embodiment shown in FIG. 6, the first length L of at least a portion of the first prisms 430b farther from the first side 411 is smaller than the first length L of at least a portion of the first prisms 430a closer to the first side 411. In addition, the first minor interior angle β₁ and the second minor interior angle β₂ of different first prisms 430a/430b are substantially identical. Furthermore, the apex angle included between the first major prism face 431 and the first minor prism face 433 becomes larger when approaching the central part 415. However, different from the embodiment shown in FIG. 6, there are no spacings between adjacent first prisms 430a/430b. In terms of the manufacturing process, the aforementioned structural configuration in this embodiment can be achieved without using a rotary knife, instead using a method that involves cutlery replacement with height and spacing adjustments.

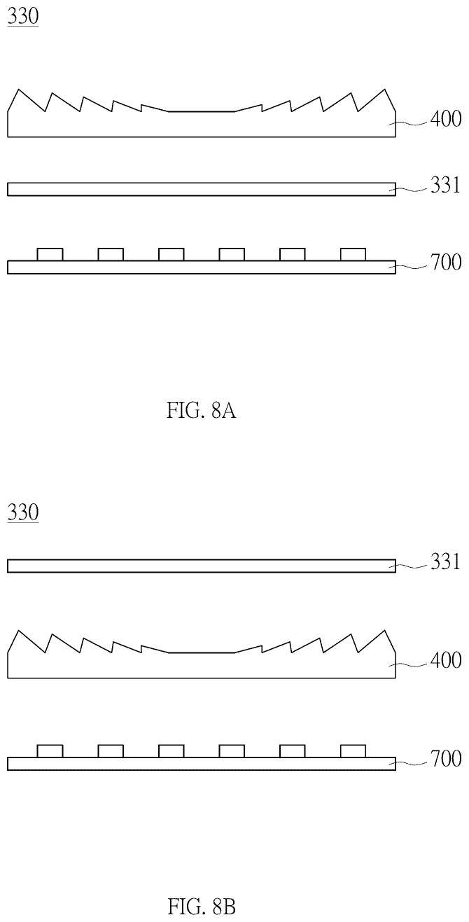

As shown in FIG. 8A, the backlight module 330 may include a brightness enhancement film 331. The brightness enhancement film 331 can be a prism sheet, a reflective polarizer, or other optical films. In this embodiment, the brightness enhancement film 331 is disposed between the optical shifting film 400 and the light source module 700. This configuration can reduce the chance of generating Moiré patterns, enhancing optical quality. In the embodiment of FIG. 8B, the optical shifting film 400 is disposed between the brightness enhancement film 331 and the light source module 700, and such a configuration can enhance the brightness of the light field.

In another embodiment shown in FIG. 8C, the backlight module 330 further includes a first prism sheet 333 and a second prism sheet 335. The first prism sheet 333 and the second prism sheet 335 are sequentially stacked between the light source module 700 and the optical shifting film 400. Specifically, the first prism sheet 333 is disposed between the light source module 700 and the optical shifting film 400, and the second prism sheet 335 is disposed between the first prism sheet 333 and the optical shifting film 400. Each of the first prism sheet 333 and the second prism sheet 335 has a first prism direction 337 and a second prism direction 339, respectively. The first prism direction 337 and the second prism direction 339 are the extension directions of the prisms on the first prism sheet 333 and the second prism sheet 335, respectively. The first prism direction 337 and the second prism direction 339 are perpendicular to each other. Since the prisms of the first prism sheet 333 and the second prism sheet 335 are disposed perpendicularly, the light pattern in both horizontal and vertical directions can be concentrated to enhance brightness. Additionally, by combining with the optical shifting film 400, the concentrated and brightness-enhanced light pattern is shifted so that the brightness can be evenly distributed across the field of view, thereby both the brightness and uniformity within the virtual eye area 500 are increased.

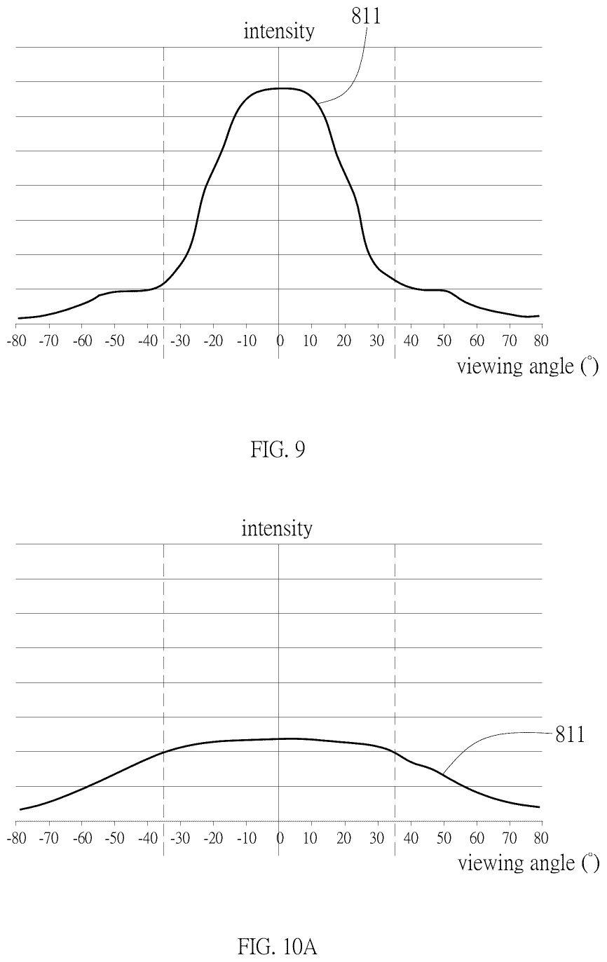

In the previous embodiments, all the first major prism faces 431 are located on the side of the first prisms 430 facing away from the first side 411, that is, the side facing toward the central part 415. Specifically, the light generated by the backlight module 330 and reflected by the projection surface 100 to the virtual eye area 500 has an emergent angle θ on the virtual cross-section that is parallel to the first direction 10 and intersects the second direction 20 upon leaving the optical shifting film 400 (refer to FIG. 5). In the embodiment shown in FIG. 10A, the maximum emergent angle θ is 35°. When the original emitted light field 811 generated by the light emitting units 710 at a viewing angle of 35° on the aforementioned virtual cross-section has an intensity higher than 80% of the maximum intensity (i.e., the peak intensity), the embodiment that all the first major prism faces 431 are located on the side of the first prisms 430 facing away from the first side 411 (i.e., the side facing toward the central part 415) can be adopted. Such a configuration can enhance the uniformity of brightness within the field of view.

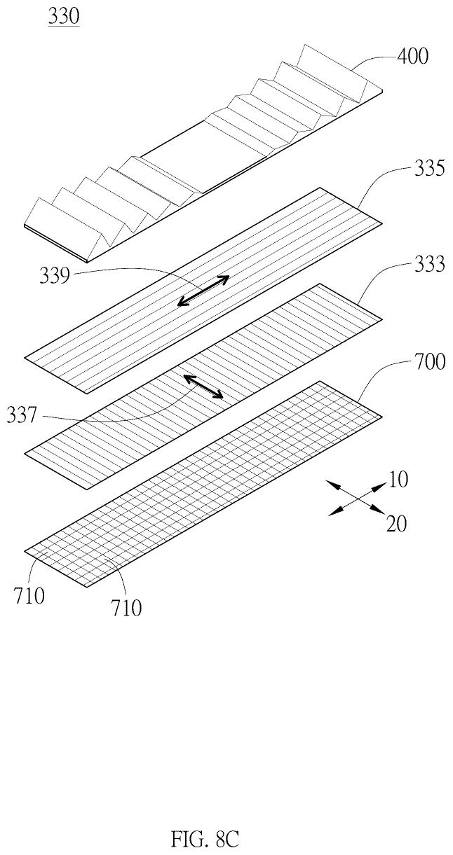

In another embodiment shown in FIG. 9, as if the maximum emergent angle θ is 35°, when the original emitted light field 811 generated by the light emitting units 710 at a viewing angle of 35° on the aforementioned virtual cross-section has an intensity lower than 80% of the maximum intensity (i.e., the peak intensity), the embodiment shown in FIG. 10B can be adopted, wherein all the first major prism faces 431 are located on the side of the first prisms 430 facing toward the first side 411 (i.e., the side facing away from the central part 415). In the embodiment shown in FIG. 10B, the emitted light field generated by at least a portion of the light emitting units 710a that are closer to the first part 417 is shifted toward the central part 415 in the first direction 10 through the first prisms 430a/430b that are disposed above and receive the corresponding light. In another aspect, the emitted light field generated by at least a portion of the light emitting units 710b that are closer to the second part 419 is shifted toward the central part 415 in the first direction 10 through the second prisms 450a/450b that are disposed above and receive the corresponding light. In other words, the light field through the first prisms 430 and the light field through the second prisms 450 are shifted toward opposite directions. Such a configuration can enhance the uniformity of brightness within the field of view.

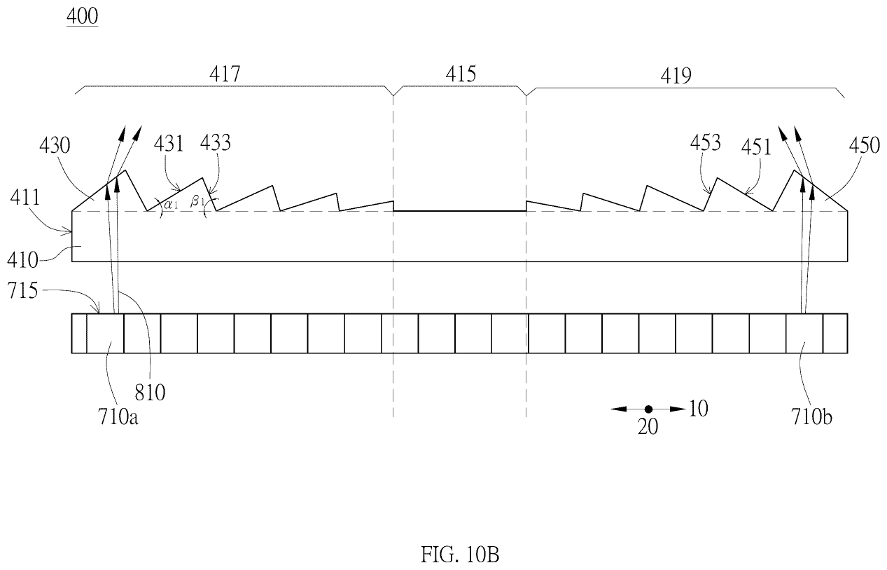

FIG. 11 shows another embodiment of the display system. In this embodiment, the projection surface 100 is a concave surface, such as an inward-curving hyperbolic surface, and the projection surface 100 is tilted relative to the line of sight (e.g., the second direction 20). The projection surface 100 has a first cross-section 110 on a second virtual upright plane 220 perpendicular to the second direction 20, wherein the first cross-section 110 has a first curvature. In addition, the display module 300 is a curved display module, wherein the display surface is a curved surface. The display module 300 has a second cross-section 320 on the second virtual upright plane 220, wherein the second cross-section 320 has a second curvature. As shown in FIG. 11, the first cross-section 110 and the second cross-section 320 are concave away from each other, and the first curvature is greater than the second curvature. In an embodiment, the second curvature is substantially 50% of the first curvature, but is not limited thereto. By the design where the first curvature is greater than the second curvature, the width and height of the global range are narrowed down, significantly lowering the design difficulty of the optical shifting film, wherein a design of 50% is preferable.

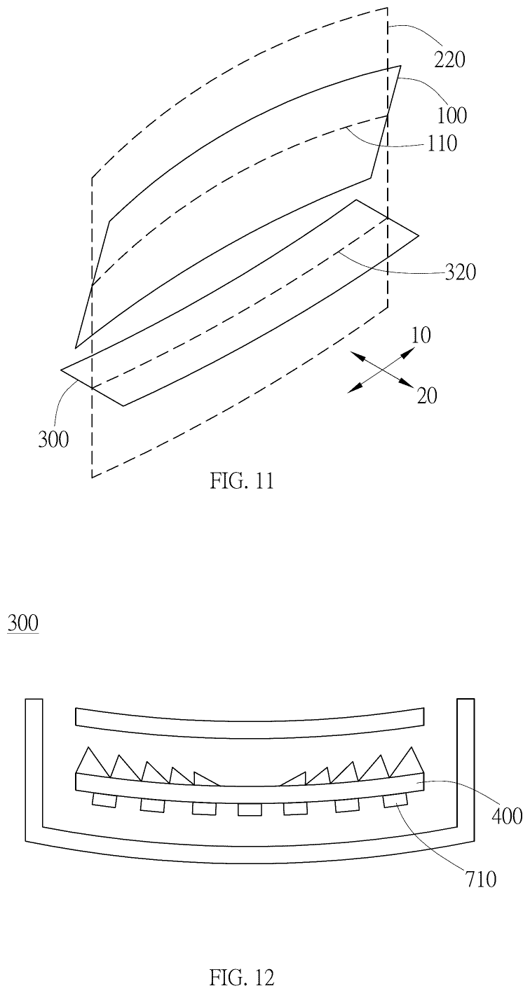

FIG. 12 is a schematic diagram of the display module 300 on the aforementioned second cross-section 320. As shown in FIG. 12, the backlight module 330 of the display module 300 includes the light source module 700 composed of multiple light emitting units 710. In this embodiment, the light emitting units 710 can be arranged in a concave manner; that is, the arrangement of the light emitting units 710 is concave away from the optical shifting film 400. This configuration allows the original emitted light field generated by each light emitting unit 710 to form an angle relative to the plane in which the first direction 10 and the second direction 20 lie, compensating for the deficiencies of the first major prism face 431 and/or the second major prism face 451 in terms of angle, thereby enhancing the uniformity of image brightness across the entire field of view.

What is claimed is:

1. An optical shifting film for a backlight module having a light source module, the light source module having a light emitting side for the optical shifting film and a plurality of light emitting units arranged in an array, the optical shifting film comprising:
a substrate having a first side intersecting a first direction and extending along a second direction; and
a plurality of first prisms disposed on the substrate, the plurality of first prisms arranged in the first direction and respectively extending along the second direction, each of the plurality of first prisms having a first major prism face,
wherein an emitted light field generated by at least a portion of the plurality of light emitting units is shifted in the first direction through at least a portion of the plurality of first prisms.

2. The optical shifting film of claim 1, wherein the substrate has a central part, a first part located between the central part and the first side, and a second part located at another side of the central part opposite to the first part; the plurality of first prisms are disposed on the first part, and the optical shifting film further comprises:
a plurality of second prisms disposed on the second part, the plurality of second prisms arranged in the first direction and respectively extending along the second direction, each of the plurality of second prisms having a second major prism face,
wherein a first emitted light field generated by at least a portion of the plurality of light emitting units closer to the first part is shifted in the first direction through the plurality of first prisms; a second emitted light field generated by at least a portion of the plurality of light emitting units closer to the second part is shifted in the first direction through the plurality of second prisms; the first emitted light field and the second emitted light field are shifted toward opposite directions.

3. The optical shifting film of claim 2, wherein a degree of shift of the emitted light field through at least a portion of the plurality of first prisms closer to the central part is less than a degree of shift of the emitted light field through at least a portion of the plurality of first prisms farther from the central part.

4. The optical shifting film of claim 2, wherein the first major prism face forms a first major interior angle with the first direction on a virtual cross-section parallel to the first direction and intersecting the second direction; the first major interior angle of at least a portion of the plurality of first prisms closer to the central part is smaller than the first major interior angle of at least a portion of the plurality of first prisms farther from the central part; the second major prism face forms a second major interior angle with the first direction on the virtual cross-section; the second major interior angle of at least a portion of the plurality of second prisms closer to the central part is smaller than the second major interior angle of at least a portion of the plurality of second prisms farther from the central part.

5. The optical shifting film of claim 1, wherein a degree of shift of the emitted light field through at least a portion of the plurality of first prisms farther from the first side is less than a degree of shift of the emitted light field through at least a portion of the plurality of first prisms closer to the first side.

6. The optical shifting film of claim 1, wherein the first major prism face forms a first major interior angle with the first direction on a virtual cross-section parallel to the first direction and intersecting the second direction; the first major interior angle of at least a portion of the plurality of first prisms farther from the first side is smaller than the first major interior angle of at least a portion of the plurality of first prisms closer to the first side.

7. The optical shifting film of claim 2, wherein the first major prism face and the second major prism face are located on surfaces of the plurality of first prisms and the plurality of second prisms facing away from the central part, respectively; the emitted light field generated by at least a portion of the plurality of light emitting units is shifted toward the central part in the first direction through at least a portion of the plurality of first prisms.

8. The optical shifting film of claim 2, wherein the first major prism face and the second major prism face are located on surfaces of the plurality of first prisms and the plurality of second prisms facing the central part, respectively; the emitted light field generated by at least a portion of the plurality of light emitting units is shifted away from the central part in the first direction through at least a portion of the plurality of first prisms.

9. The optical shifting film of claim 6, wherein the first major interior angle or the second major interior angle is greater than 0° and less than or equal to 30°.

10. The optical shifting film of claim 4, wherein a variation rate of the first major interior angles closer to the central part is greater than a variation rate of the first major interior angles farther from the central part; a variation rate of the second major interior angles closer to the central part is greater than a variation rate of the second major interior angles farther from the central part.

11. The optical shifting film of claim 6, wherein each of the plurality of first prisms has a first minor prism face opposite to the first major prism face; the first minor prism face forms a first minor interior angle with the first direction on the virtual cross-section; the first minor interior angle is less than 90° and greater than the first major interior angle.

12. The optical shifting film of claim 1, wherein the first major prism face has a first length on a virtual cross-section parallel to the first direction and intersecting the second direction; the first length of at least a portion of the plurality of first prisms farther from the first side is smaller than the first length of at least a portion of the plurality of first prisms closer to the first side.

13. The optical shifting film of claim 12, wherein the plurality of first prisms are disposed with spacing between each other; a width of the spacing for at least a portion of the plurality of first prisms farther from the first side is greater than a width of the spacing for at least a portion of the plurality of first prisms closer to the first side.

14. The optical shifting film of claim 1, wherein the plurality of light emitting units are arranged to form a second curvature on a virtual cross-section parallel to the first direction and intersecting the second direction; the second curvature is concave away from the optical shifting film; lights generated from the plurality of light emitting units pass through the optical shifting film to reach a projection surface; the projection surface forms a first cross-section on the virtual cross-section; the first cross-section has a first curvature; the first curvature is greater than the second curvature.

15. The optical shifting film of in claim 1, wherein the backlight module further comprises a brightness enhancement film; the optical shifting film is located between the brightness enhancement film and the light source module.

16. The optical shifting film of in claim 1, wherein the backlight module further comprises:
a first prism sheet disposed between the optical shifting film and the light source module, the first prism sheet having a first prism direction; and
a second prism sheet disposed between the optical shifting film and the first prism sheet, the second prism sheet having a second prism direction,
wherein the first prism direction is perpendicular to the second prism direction.

17. A display system, comprising:
a projection surface;
a display module comprising a backlight module, the backlight module having a light source module, the light source module having a light emitting side and a plurality of light emitting units arranged in an array; and
the optical shifting film of claim 1, disposed on the light emitting side; and
a virtual eye area,
wherein the display module is disposed corresponding to the projection surface and generates an image light; the image light is reflected by the projection surface to generate an image at least in the virtual eye area.

18. The display system of claim 17, wherein the virtual eye area has a first upright central axis; the projection surface has a second upright central axis; the first upright central axis and the second upright central axis together define a virtual upright plane; an intersection line between the virtual upright plane and the display module has a midpoint; by extending from the midpoint in a direction perpendicular to the first direction and parallel to the display module, an axis of symmetry is formed; the optical shifting film exhibits bilateral symmetry with respect to the axis of symmetry.

19. The display system of claim 17, wherein light generated by the backlight module and reflected by the projection surface to the virtual eye area has a maximum emergent angle θ on a virtual cross-section parallel to the first direction and intersecting the second direction upon leaving the optical shifting film; the first major prism face on each of the plurality of first prisms is located facing toward the first side when an emitted light field generated by the plurality of light emitting units at a viewing angle of θ has an intensity lower than 80% of the maximum intensity.

20. The display system of claim 17, wherein light generated by the backlight module and reflected by the projection surface to the virtual eye area has a maximum emergent angle θ on a virtual cross-section parallel to the first direction and intersecting the second direction upon leaving the optical shifting film; the first major prism face on each of the plurality of first prisms is located facing away from the first side when an emitted light field generated by the plurality of light emitting units at a viewing angle of θ has an intensity higher than 80% of the maximum intensity.

21. The display system of claim 17, wherein light generated by the backlight module and reflected by the projection surface to the virtual eye area has a maximum emergent angle θ on a virtual cross-section parallel to the first direction and intersecting the second direction upon leaving the optical shifting film; each of the plurality of first prisms has a first minor prism face opposite to the first major prism face; the first minor prism face forms a first minor interior angle with the first direction on the virtual cross-section; the first minor interior angle is less than or equal to the maximum emergent angle θ.
